(19) United States
(12) Patent Application Publication
(10) Pub. No.: US 2015/0244989 A1
(43) Pub. Date: Aug. 27, 2015

(54) SURVEILLANCE SYSTEM, SURVEILLANCE CAMERA AND METHOD FOR SECURITY SURVEILLANCE

(71) Applicant: Transcend Information, Inc., Taipei City (TW)

(72) Inventor: Mao-Yu LIAO, New Taipei City (TW)

(73) Assignee: Transcend Information, Inc., Taipei City (TW)

(21) Appl. No.: 14/191,444

(22) Filed: Feb. 27, 2014

(51) Int. Cl. H04N 7/18; H04N 5/232

(52) U.S. Cl. CPC H04N 7/181; H04N 5/23296

(57) ABSTRACT

A surveillance system, a surveillance camera, and a method for security surveillance are provided. The surveillance system includes at least one first surveillance camera and a second surveillance camera electrically connected to the first surveillance camera via networks. When the first surveillance camera detects and determines that the second surveillance camera is disabled, the first surveillance camera changes a first viewing zone to overlap a second viewing zone of the second surveillance camera.

### BACKGROUND

1. Field of Disclosure

The present disclosure relates to surveillance system. More particularly, the present disclosure relates to surveillance system, a surveillance camera, and a method for security surveillance.

2. Description of Related Art

Recently, surveillance cameras in a security surveillance system are respectively deployed at different parts of a single-floor area, and the surveillance cameras are respectively used to monitor the different parts of the single-floor area for security surveillance. Since the surveillance cameras are connected to a control center via networks, the surveillance cameras respectively capture real-time videos and respectively output to the control center via the networks. Thus, a user at the control center is able to view the real-time videos captured by the surveillance cameras via a monitor screen remotely, so the user can take actions according to the real-time videos shown on the monitor screen, especially when an abnormality appears in the real-time videos.

However, since the surveillance cameras respectively provide different viewing zones of the single-floor area, once one of the surveillance cameras is disabled, the disabled surveillance camera fails to provide the real-time videos of the viewing zone which the disabled surveillance camera originally covers via the monitor screen, and neither do the other surveillance cameras, so that a security vulnerability is existed in the security surveillance system. Even if the user arrives the single-floor area from the control center quickly, damages or loses in the single-floor area might has been happened already before the user arrives the disabled surveillance camera from the control center.

### SUMMARY

In view of the above, an object of the present disclosure is to provide a surveillance system, a surveillance camera, and a method for security surveillance for solving the mentioned disadvantages existed in prior art, that is, once one of surveillance cameras is disabled, at least one of the others will support the disabled surveillance camera for outwardly transmitting the real-time videos of the viewing zone which the disabled surveillance camera originally covers, so that the security vulnerability existed in the surveillance system can be overcome.

In order to achieve the aforementioned object, according to an embodiment, a surveillance camera comprises a connecting unit, a camera lens having a first viewing zone, a processing unit and a viewing-zone changing element. The connecting unit can communicate with other surveillance cameras via networks. The processing unit electrically connects to the camera lens and the connecting unit, and detects and determines whether anyone of the other surveillance cameras is disabled by communicating with the other surveillance cameras with the connecting unit. The viewing-zone changing element is electrically connected to the processing unit, and changes the first viewing zone to overlap a second viewing zone of the disabled surveillance camera.

Therefore, since the first viewing zone overlaps the second viewing zone of the disabled surveillance camera, the real-time videos of the first viewing zone of the surveillance camera are transmitted outwardly via the networks, the second viewing zone which the disabled surveillance camera originally covers still can be viewed and monitored remotely.

According to another aspect in one or more embodiments, a surveillance system comprises at least one first surveillance camera having a first viewing zone, and one second surveillance camera having a second viewing zone being different from the first viewing zone. The second surveillance camera electrically connects to the first surveillance camera via networks. When the first surveillance camera detects and determines that the second surveillance camera is disabled the first surveillance camera actively changes the first viewing zone to overlap the second viewing zone of the second surveillance camera.

According to another aspect in one or more embodiments, a method for security surveillance is implemented on at least one of surveillance cameras covering a first viewing zone, and the method comprising steps as follows. Electrically connecting to the other surveillance cameras via networks; next, communicating to the other surveillance cameras via the networks, and detecting and determining whether another of the surveillance cameras is disabled for outputting real-time videos of a second viewing zone, then, changing the first viewing zone thereof to overlap the second viewing zone of the disabled surveillance camera.

As what has been disclosed above, by the technical solution provided by the present disclosure, no matter any surveillance camera is malfunctioned, damaged or blocked, since one or more the other surveillance cameras can overlap their viewing zones on the viewing zone which the disabled surveillance camera originally covers, the viewing zone which the disabled surveillance camera originally covers still can be viewed and monitored, and the real-time videos thereof still can be outputted outwardly via the networks, so that the security vulnerability existed in the surveillance system can be overcome.

The above description is merely used for illustrating the problems to be resolved, the technical methods for resolving the problems and their efficacies, etc. The specific details of the present disclosure will be explained in the below embodiments and related drawings.

### BRIEF DESCRIPTION OF THE DRAWINGS

The disclosure may be more fully understood by reading the following detailed description of the embodiment, with reference made to the accompanying drawings as follows:

FIG. 1 is a block diagram illustrating a surveillance system according to a first embodiment of the disclosure;

FIG. 2A is a block diagram illustrating each of the surveillance cameras of FIG. 1;

FIG. 2B is a schematic view illustrating each of the surveillance cameras of FIG. 1;

FIG. 3A and FIG. 3B are practice schematic views illustrating a surveillance system exercising in a single-floor area according to a second embodiment of the disclosure;

FIG. 4 is a block diagram illustrating a surveillance camera according to a second embodiment of the disclosure; and

FIG. 5 is a schematic view illustrating an action table using in FIG. 3A and FIG. 3B according to the second embodiment of the disclosure;

FIG. 6 is a block diagram illustrating a surveillance camera according to a third embodiment of the disclosure;

FIG. 7 is a flowchart illustrating a method for security surveillance according to a fourth embodiment of the disclosure;

FIG. 8 is a flowchart illustrating one variation of the fourth embodiment of the disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present disclosure. That is, these details of practice are not necessary in parts of embodiments of the present disclosure. Furthermore, for simplifying the drawings, some of the conventional structures and elements are shown with schematic illustrations.

### First Embodiment

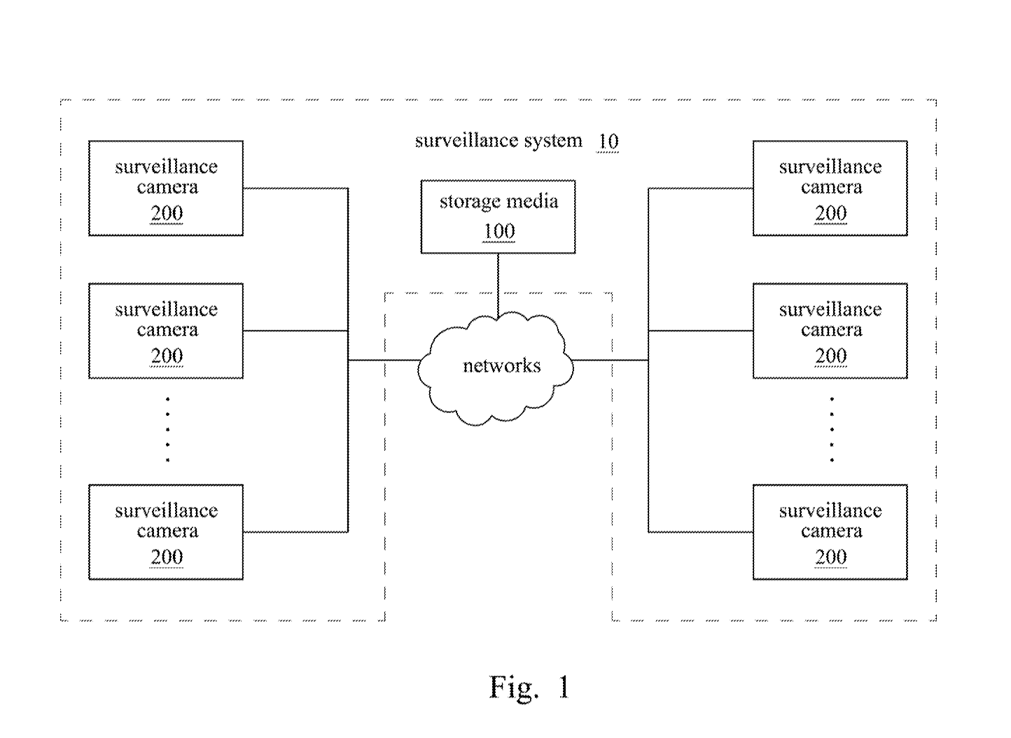

Reference is now made to FIG. 1 in which FIG. 1 is a block diagram illustrating a surveillance system 10 according to a first embodiment of the disclosure. As shown in FIG. 1, in the embodiment, the surveillance system 10 at least comprises a plurality of surveillance cameras 200. These surveillance cameras 200 are respectively deployed at different parts of a single-floor area, thus, these surveillance cameras 200 respectively have a viewing zone different to each other, that is, each surveillance camera 200 covers a different viewing zone of the single-floor area from the other surveillance cameras 200. Thus, these surveillance cameras 200 respectively transmit and record the real-time videos of the corresponding viewing zone of the single-floor area outwardly to a storage media 100 (e.g., digital video recorder, DVR). The surveillance cameras 200 are electrically connected with each other via networks, in particular, in this embodiment, the surveillance cameras 200 are electrically connected with each other via wired/wireless networks, so that the surveillance cameras 200 can communicate with each other via the wired/wireless networks.

In the first embodiment, when one of the surveillance cameras 200 (called as a first surveillance camera hereinafter) covering a first viewing zone thereof detects and determines that another of the surveillance cameras 200 (called as second surveillance camera hereinafter) is failed for outputting real-time videos of a second viewing zone thereof as a disable surveillance camera, the first surveillance camera will actively change the first viewing zone of the single-floor area to overlap the second viewing zone of the second surveillance camera, and will transmit the real-time videos of the first/second viewing zone outwards to the storage media 100. The real-time videos of the first/second viewing zone will be stored in the storage media 100 thereafter.

Due to the first surveillance camera, the second viewing zone which the second surveillance camera originally covers still can be viewed and monitored, and the real-time videos thereof still can be outputted and recorded outwardly via the wired/wireless networks. Thus, the security vulnerability existed in the surveillance system 10 can be overcome.

In this specification, the so called disabled surveillance camera can be defined as a surveillance camera that is not able to cover the desired viewing zone or specific areas of the zone, such as a failure in communication with other surveillance camera, a malfunction with the surveillance camera being unable to output real-time videos of the desired viewing zone or specific areas of the zone, an intentional or unintentional tuning off the power of the surveillance camera, an intentional or unintentional blocking the field of view (FOV) of the surveillance camera, or an intentional or unintentional movement of the surveillance camera (e.g., the camera is pushed toward the ceiling or the wall).

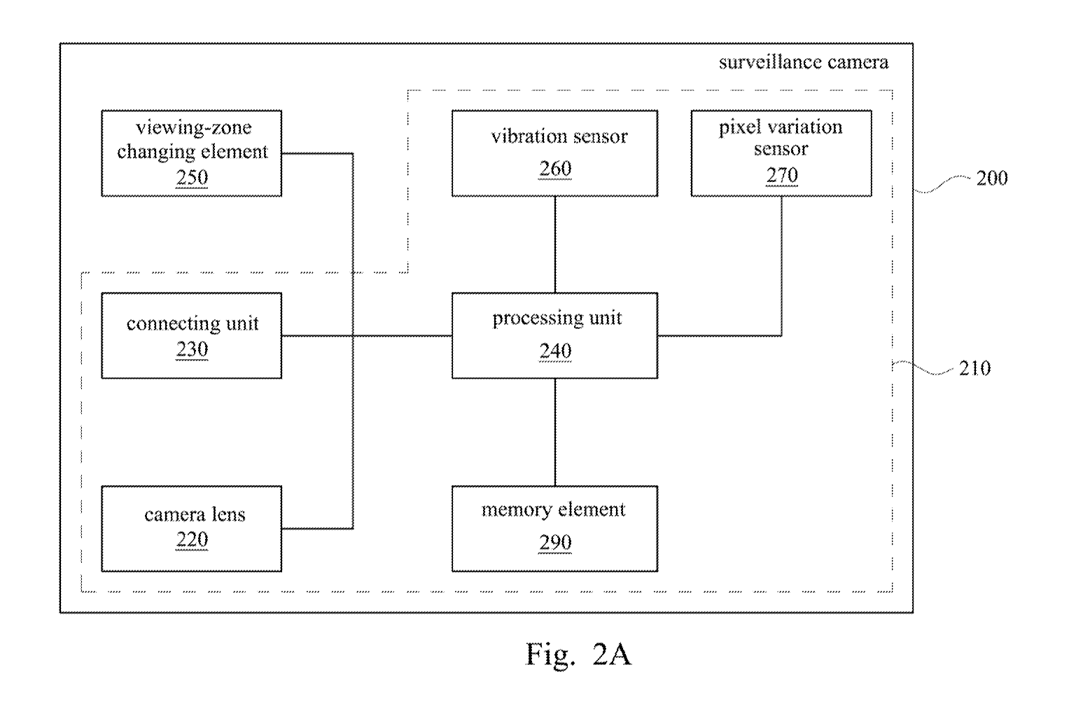

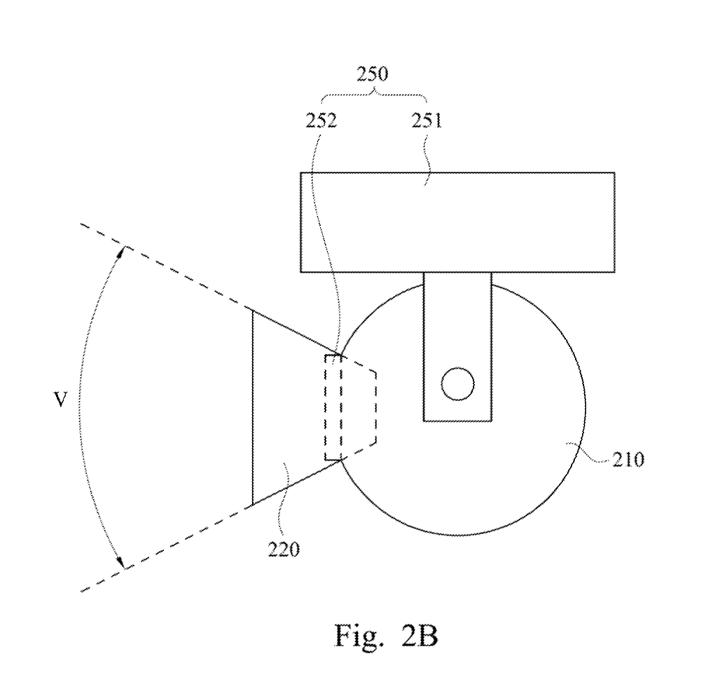

Reference is now made to FIG. 2A and FIG. 2B in which FIG. 2A is a block diagram illustrating each of the surveillance cameras 200 of FIG. 1, and FIG. 2B is a schematic view illustrating each of the surveillance cameras 200 of FIG. 1. Substantially, refer to FIG. 2A, the surveillance camera 200 comprises a case 210, in which a camera lens 220, a connecting unit 230 (e.g., wired/wireless network interface card or I/O port), a memory element 290 and a processing unit 240 are disposed therein, and a viewing-zone changing element 250 is connected to the case 210. The camera lens 220 covers a viewing zone V (FIG. 2B), captures real-time videos of the viewing zone V and outputs the real-time videos thereof outwardly to the storage media 100 via the connecting unit 230. The connecting unit 230 is configured for the surveillance camera 200 to be able to electrically connect to the other surveillance cameras 200 via the wired/wireless networks, and the processing unit 240 of the surveillance camera 200 electrically connects to the other surveillance cameras 200 via the connecting unit 230. The processing unit 240 of the surveillance camera 200 communicates with the other surveillance cameras 200 in order to detect and determine whether any of the other surveillance cameras 200 is disabled. If any of the other surveillance cameras 200 is detected or determined as a disabled surveillance camera (i.e., second surveillance camera), the viewing-zone changing element 250 changes the viewing zone V (i.e., first viewing zone) of the camera lens 220 to overlap the viewing zone (i.e., second viewing zone) of the disabled surveillance camera. The memory element 290 electrically connects to the processing unit 240, and the memory element 290 can be a volatile memory (e.g., SRAM, DRAM etc.) or a non-volatile memory (e.g., EEPROM, FLASH etc.), or even a traditional hard disk drive (HDD).

Also, in the first embodiment, each of the surveillance cameras 200 comprises a vibration sensor 260. The vibration sensor 260 electrically connects to the processing unit 240. When the surveillance camera 200 is intentionally or unintentionally vibrated overly, and the vibration sensor 260 detects that the vibration of the surveillance camera 200 is happened, the vibration sensor 260 send a first abnormal signal as an indication signal to the processing unit 240. The processing unit 240 then broadcasts the first abnormal signal to at least one of the other surveillance cameras 200 via the wired/wireless networks. This surveillance camera 200 therefore is defined as a disabled surveillance camera by the other surveillance cameras 200 when receiving the first abnormal signals by their connecting units 230, respectively. It is noted that the vibration sensor 260 in the embodiment will send the first abnormal signal to the processing unit 240 if the vibration sensor 260 detects that the vibration of the surveillance camera 200 is greater than a certain degree from an external force. In the embodiment, the vibration sensor 260 can be a G-sensor, V-sensor or alike, however, the disclosure is not limited thereto.

Moreover, each of the surveillance cameras 200 further comprises a pixel variation sensor 270. The pixel variation sensor 270 electrically connects to the processing unit 240. When the pixel variation sensor 270 of the surveillance camera 200 detects that at least two frames of the real-time videos of the viewing zone V are mainly different, that is, the surveillance camera 200 might be intentionally or unintentionally pushed away from the original viewing zone, or totally blocked (e.g., by a black cloth), thus, the pixel variation sensor 270 sends a second abnormal signal as an indication signal to the processing unit 240. The processing unit 240 then broadcasts the second abnormal signal to at least one of the other surveillance cameras 200 via the wired/wireless networks. The surveillance camera 200 therefore is defined as a disabled surveillance camera by the other surveillance cameras 200 when receiving the second abnormal signals by their connecting units 230, respectively. It is noted that the pixel variation sensor 270 in the embodiment will send the second abnormal signal to the processing unit 240 if the pixel variation sensor 270 detects that a difference existed between at least two frames of the real-time videos of the viewing zone V exceeds over a predetermined percentage (e.g., 60% -100%).

In the disclosure, the pixel variation sensor 270 is not limited to exist in hardware, software or firmware only. For example, the pixel variation sensor can be integrally inbuilt in the processing unit to be a part of the processing unit, or the pixel variation sensor can be a function that the processing unit provides.

In the first embodiment, the vibration sensor 260 and the pixel variation sensor 270 both installed in the surveillance camera 200 provide more than one method to notify the other surveillance cameras 200 that this surveillance camera 200 is disabled, however, the vibration sensor and the pixel variation sensor are not essential elements of this surveillance camera, due to cost or space consideration, in another embodiment, one of the vibration sensor and the pixel variation sensor might be optionally omitted in the surveillance camera.

In the disclosure, these surveillance cameras are not limited to analog or digital cameras, digital Internet Protocol (IP) cameras, Pan-Tilt-Zoom (PTZ) camera, or any combination of fixed and/or Pan-Tilt-Zoom (PTZ) cameras.

In one possible of the embodiment, refer to FIG. 2B, when each of the surveillance cameras 200 is a Pan-Tilt-Zoom (PTZ) camera, the viewing-zone changing element 250 can be a pan-tilt mechanism 251. The pan-tilt mechanism 251 can pan as to rotate horizontally, or tilt as to rotate vertically, or can both rotate horizontally and vertically. The pan-tilt mechanism 251 is rotatably disposed on the camera lens 220. Thus, when the pan-tilt mechanism 251 rotates, the camera lens 220 is rotated along with the pan-tilt mechanism 251 in accordance with a predetermined rotation angle stored in the memory element 290 in advance, and the viewing zone (i.e., first viewing zone) of the camera lens 220 can be moved (or changed) to overlap the viewing zone (i.e., second viewing zone) which the disabled surveillance camera (i.e., second surveillance camera) originally covers.

Also, in another possible of the embodiment, the viewing-zone changing element 250 further comprises a zooming element 252. The zooming element 252 is adjustably disposed on the camera lens 220. Thus, when the zooming element 252 zooms in or out, the viewing zone V is magnified or shrunk in size in accordance with a predetermined zooming percentage stored in the memory element 290 in advance for overlapping the viewing zone (i.e., second viewing zone) which the disabled surveillance camera (i.e., second surveillance camera) originally covers.

It is noted, the zooming element 252 and the pan-tilt mechanism 251 are not exclusively existed in a single surveillance camera 200, that is, the surveillance camera 200 both having the zooming element 252 and the pan-tilt mechanism 251 can respectively rotate or zoom in/out to change the viewing zone V for overlapping the viewing zone which the disabled surveillance camera originally covers.

### Second Embodiment

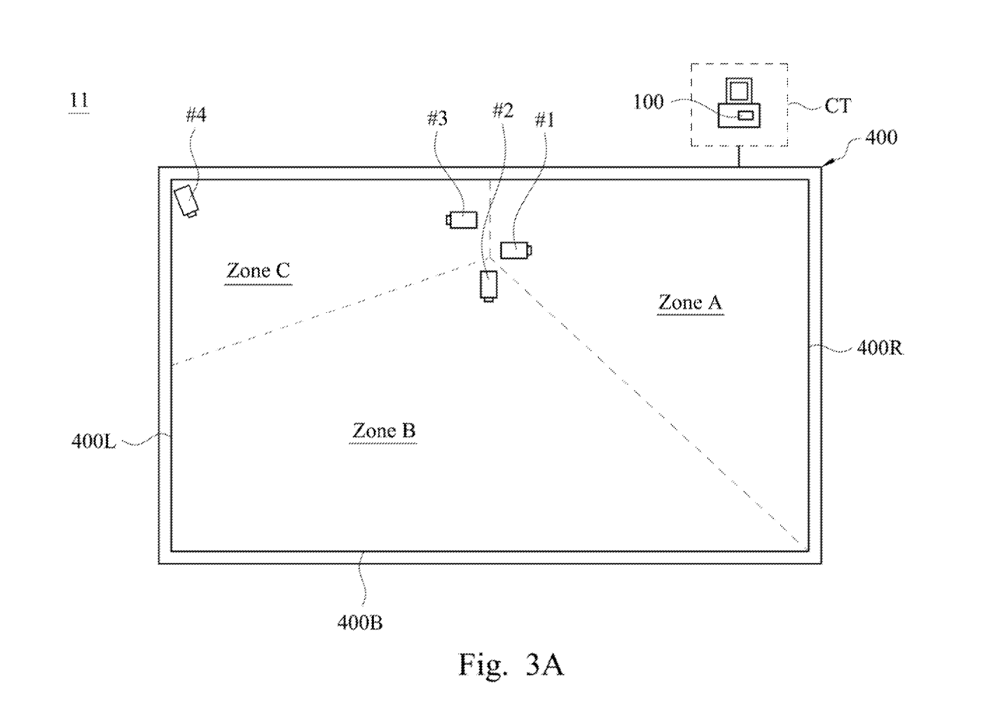

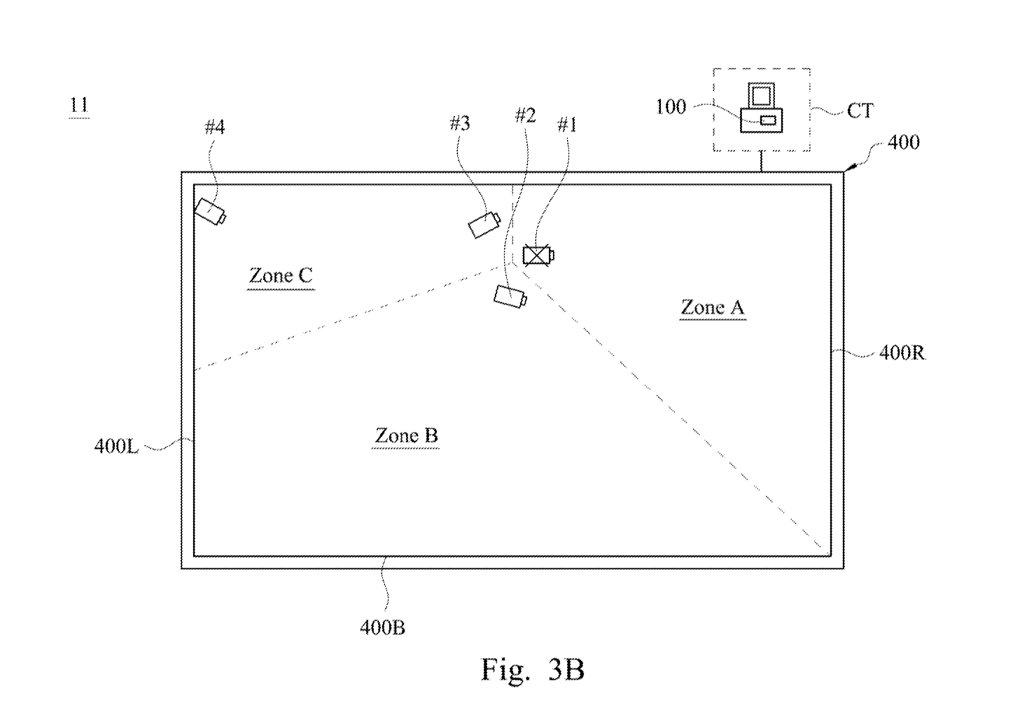

FIG. 3A and FIG. 3B are practice schematic views illustrating a surveillance system 11 exercising in a single-floor area 400 according to a second embodiment of the disclosure. For example, refer to FIG. 3A, the surveillance system 11 includes surveillance cameras #1 to #4, for monitoring a single-floor area 400 having zones A to C in which the surveillance camera #1 is located at the zone A and provides a viewing zone facing towards a right side 400R of the single-floor area 400, the surveillance camera #2 is located at the zone B and provides a viewing zone facing towards a bottom side 400B of the single-floor area 400, the surveillance camera #3 is located at the zone C and provides a viewing zone facing towards a left side 400L of the single-floor area 400, and the surveillance camera #4 is also located at the zone C and provides a viewing zone facing towards the bottom side 400B of the single-floor area 400.

The surveillance system 11 further optionally includes a control center CT as a computer-like device having the storage media 100 therein. The control center CT is respectively and electrically connected to the surveillance cameras #1 to #4 via the wired/wireless networks so that the real-time videos of the viewing zones of the surveillance cameras #1 to #4 can be transmitted to the control center CT and recorded to the storage media 100. Thus, a user at the control center CT is able to view the real-time videos captured by the surveillance cameras #1 to #4 remotely, so the user can take actions according to the real-time videos shown on the control center CT, especially when an abnormality appears in the real-time videos.

Refer to FIG. 3B, once the surveillance camera #1 is detected and determined to be disabled by at least one of the surveillance cameras #2 to #4, the surveillance camera #2, #3 or #4, or all of the surveillance camera #2 to #4 will rotate or zoom in/out for overlapping its/theirs viewing zones on the viewing zone which the surveillance camera #1 originally covers. More particularly, when all of the surveillance cameras #2 to #4 detect and determine that the surveillance camera #1 is defined as a disable surveillance camera, all of the surveillance cameras #2 to #4 will rotate or zoom in/out for overlapping theirs viewing zones on the viewing zone which the surveillance camera #1 originally covers.

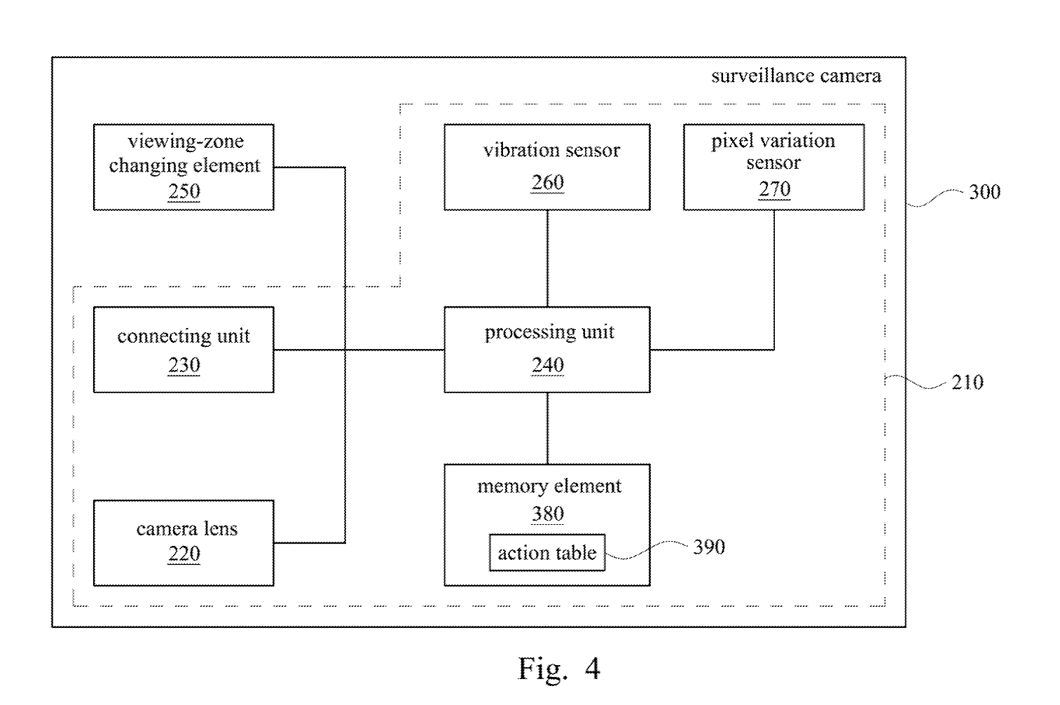

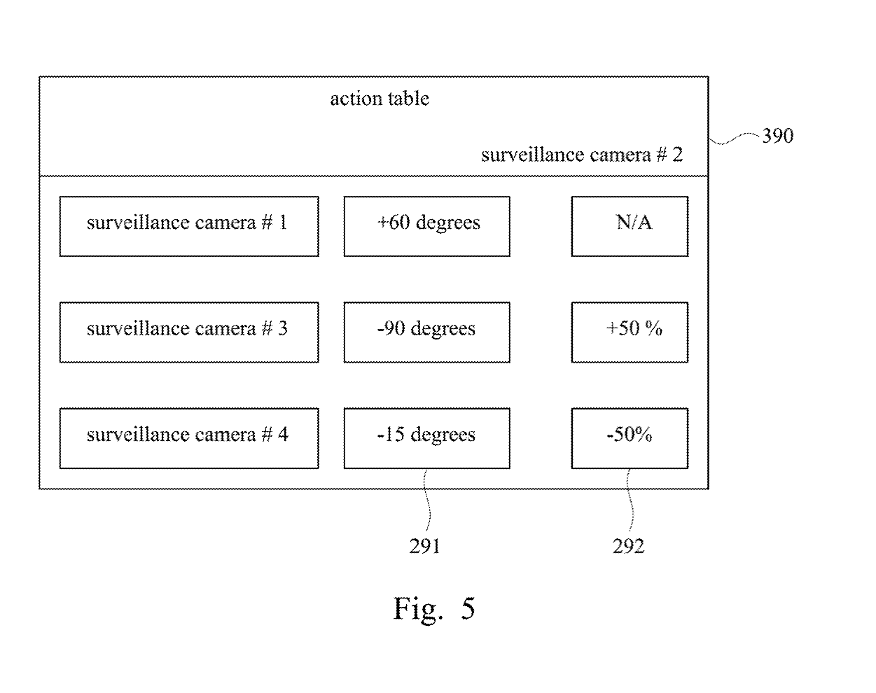

Reference is now made to FIG. 4 and FIG. 5 in which FIG. 4 is a block diagram illustrating a surveillance camera 300 according to the second embodiment of the disclosure, and FIG. 5 is a schematic view illustrating an action table 390 using in FIG. 3A and FIG. 3B according to the second embodiment of the disclosure. The surveillance camera 300 is substantially the same as the surveillance camera 200 of the first embodiment except that the surveillance camera 300 further includes a memory element 380 electrically connects to the processing unit 240, and an action table 390 written with a number of predetermined rotation angles 291 in advance is stored in the memory element 380. The memory element 380 can be a volatile memory (e.g., SRAM, DRAM etc.) or a non-volatile memory (e.g., EEPROM, FLASH etc.), or even a traditional hard disk drive (HDD). Each of the predetermined rotation angles 291 corresponds to one of the other surveillance cameras 300; in other words, every surveillance camera 300 can be preliminarily set with a number of rotation angles in correspondence to the other surveillance cameras 300 if one of the other surveillance cameras 300 is disabled.

For example, refer to FIG. 5, the action table 390 of the surveillance camera #2 is written with three records of the predetermined rotation angles 291. When the surveillance camera #1 is disabled, the surveillance camera #2 rotates 60 degrees for overlapping the viewing zone which the surveillance camera #1 previously covers; when the surveillance camera #3 is disabled, the surveillance camera #2 rotates −90 degrees for overlapping the viewing zone which the surveillance camera #3 previously covers; and when the surveillance camera #4 is disabled, the surveillance camera #2 rotates −15 degrees for overlapping the viewing zone which the surveillance camera #4 originally covers.

Furthermore, the action table 390 is further preliminarily written with predetermined zooming percentages 292. Each of the predetermined zooming percentages 292 corresponds to one of the other surveillance cameras 300; in other words, every surveillance camera 300 can be preliminarily set a number of zooming percentages in correspondence to the other surveillance cameras 300 if one of the other surveillance cameras 300 is disabled.

It is noted, the predetermined zooming percentage 292 and the predetermined rotation angle 291 are not exclusively existed in a single action table 390, that is, the action table 390 having both the predetermined zooming percentage 292 and the predetermined rotation angle 291 can respectively provide a surveillance camera 300 to overlap the viewing zone which the disabled surveillance camera originally covers by rotating or zooming the viewing zone. Also, in other embodiments, the action table of the surveillance camera can only be provided with predetermined zooming percentages therein without the predetermined rotation angle.

Refer to FIG. 5 again, the action table 390 of the surveillance camera #2 is written with three records of the predetermined rotation angles 291 and the predetermined zooming percentages 292. When the surveillance camera #3 is disabled, the surveillance camera #2 rotates −90 degrees and then zooms its viewing zone in 50% for overlapping the viewing zone which the surveillance camera #3 originally covers; and when the surveillance camera #4 is disabled, the surveillance camera #2 rotates −15 degrees and zooms its viewing zone out 50% for overlapping the viewing zone which the surveillance camera #4 originally covers.

### Third Embodiment

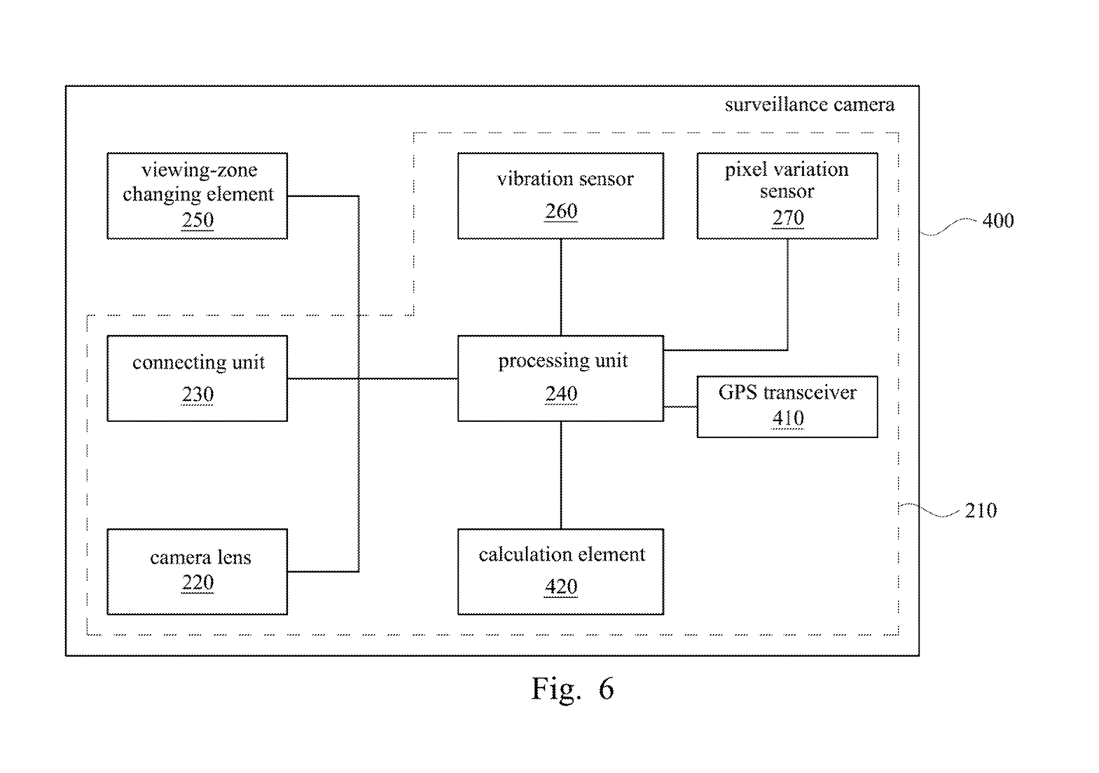

Reference is now made to FIG. 6 in which FIG. 6 is a block diagram illustrating a surveillance camera 400 according to a third embodiment of the disclosure. The surveillance camera 400 is substantially the same as the surveillance camera 200 of the first embodiment except that the surveillance camera 400 further includes a positioning transceiver 410, e.g., a global position system (GPS) transceiver, and a calculation element 420. The positioning transceiver 410 electrically connects to the processing unit 240. The positioning transceiver 410 is configured to output a location data, such as GPS data, of the surveillance camera 400 for notifying the GPS coordinate to the other surveillance cameras 400. The calculation element 420 electrically connects to the processing unit 240. When one of the surveillance cameras 400 obtains location data of the disabled surveillance camera, the calculation element 420 will calculate to generate a suggested rotation angle by using the location data and at least one algorithm. Thus, the surveillance cameras 400 can change its viewing zone to overlap the viewing zone which the other surveillance camera 400 originally covers by rotating in accordance with the suggested rotation angle.

### Fourth Embodiment

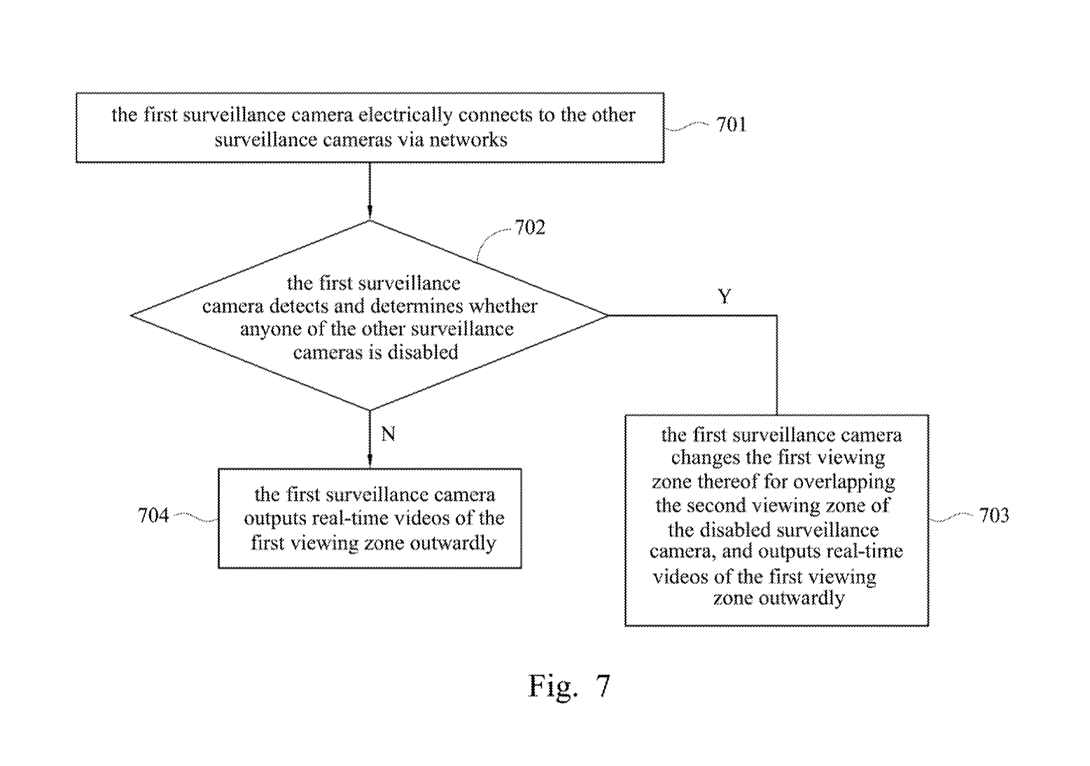

Reference is now made to FIG. 7 in which FIG. 7 is a flowchart illustrating a method for security surveillance according to a fourth embodiment of the disclosure. In the fourth embodiment, the method for security surveillance is implemented on anyone surveillance camera (called as first surveillance camera hereinafter) and the first surveillance camera covers a first viewing zone. The first surveillance camera follows the method having Step 701 to Step 704 outlined below for supporting a disabled surveillance camera (called as second surveillance camera hereinafter) originally covering a second viewing zone different to the first viewing zone.

In Step 701, the first surveillance camera electrically connects to the other surveillance cameras via the networks. In Step 702, the first surveillance camera detects and determines whether anyone of the other surveillance cameras is disabled for outputting real-time videos of the second viewing zone by communicating to the other surveillance cameras via the networks. If yes, go to Step 703, otherwise, go to Step 704. In Step 703, the first surveillance camera changes the first viewing zone thereof to overlap the second viewing zone of the second surveillance camera, and outputs the real-time videos of the first viewing zone which covering the second viewing zone outwardly. In Step 704, the first surveillance camera does not change the first viewing zone thereof, and outputs the real-time videos of the first viewing zone outwardly.

In Step 701, specifically, the first surveillance camera actively requests the other surveillance cameras respectively to reply in a predetermined time via the networks periodically or randomly; then the first surveillance camera detects and determines whether anyone of the surveillance cameras fails to reply in the predetermined period via the networks. When one of the surveillance cameras fails to reply to the first surveillance camera in the predetermined period, the first surveillance camera determines that the one of the surveillance cameras 300 failing to reply is disabled.

Substantially, refer to FIG. 2, the connecting unit 230 respectively transmits a request for reply to the connecting units 230 of the other surveillance cameras 200 in a predetermined time via the networks periodically or randomly; then, the processing unit 240 waits to detect and determine whether anyone of the surveillance cameras 200 fails to return a reply in the predetermined period via the networks because of being out of service. Finally, after the processing unit 240 determines that the one of the surveillance cameras 200 fails to return the reply, the processing unit 240 defines that the surveillance camera 200 is disabled.

In one variation of the embodiment, In Step 701, specifically, the first surveillance camera passively detects and determines whether another surveillance camera is functionally interrupted by communicating with other surveillance cameras periodically or randomly via the networks, then, when anyone of the surveillance cameras is determined to be functionally interrupted, the one is determined to be disabled.

Substantially, refer to FIG. 1, every surveillance camera 200 will periodically or randomly detect to determine whether an indication signal (e.g., first abnormal signal or second abnormal signal mentioned above) from anyone of the other surveillance cameras 200 is received via the networks. If the indication signal (e.g., first abnormal signal or second abnormal signal mentioned above) is received from another surveillance camera 200, the surveillance camera 200 broadcasting the indication signal (e.g., first signal or second signal mentioned above) is determined as a disabled surveillance camera.

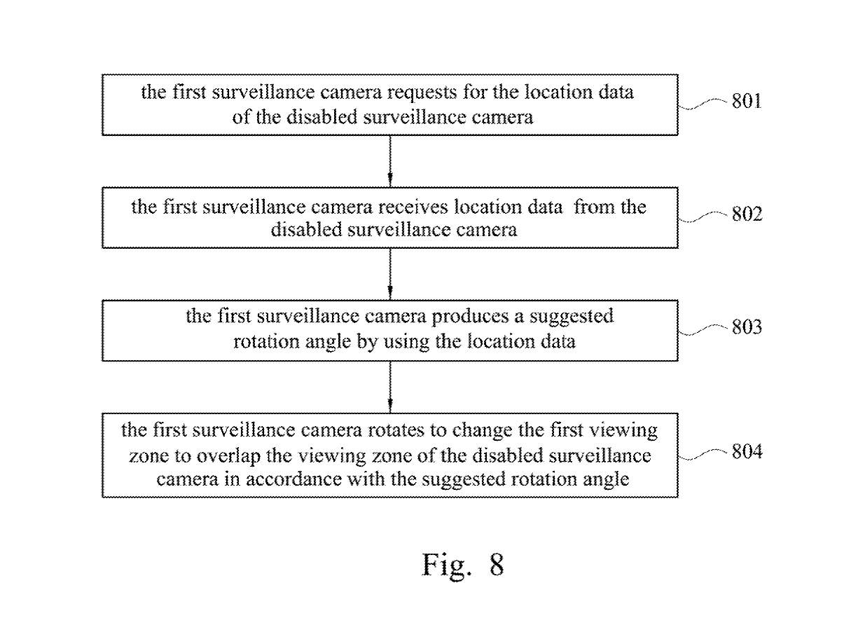

As shown in FIG. 8, FIG. 8 is a flowchart illustrating one variation of the fourth embodiment of the disclosure. Between Step 702 and Step 703 of FIG. 7, Step 801 to Step 804 are further provided as follows. In Step 801, the first surveillance camera requests for the location data, such as GPS data, of the disabled surveillance camera after the disabled surveillance camera is determined. In Step 802, the first surveillance camera receives location data from the disabled surveillance camera. In Step 803, the first surveillance camera produces a suggested rotation angle by using the location data; and In Step 804, the first surveillance camera rotates to change the first viewing zone to overlap the viewing zone of the disabled surveillance camera in accordance with the suggested rotation angle.

However, the invention is not limited thereto, in another option, the first surveillance camera does not receive the location data of the disabled surveillance camera from the disabled surveillance, the first surveillance camera retrieves the location data of the disabled surveillance camera from a preliminary provided table in the storage element of the first surveillance camera.

To be noted, when the aforementioned surveillance cameras electrically connect with each other wirelessly, the aforementioned surveillance cameras can connect with each other through wireless networks of (1) wireless personal area network (e.g., Bluetooth), (2) wireless local area network (e.g., Wireless Fidelity, IEEE 802.11a, b, g and n), (3) wireless metropolitan area network (e.g., WiMax) or (4) wireless wide metropolitan area network (e.g., 3G). On the other hand, when the aforementioned surveillance cameras electrically connect with each other by wires, the aforementioned surveillance cameras can connect with each other through USB cables or network (Ethernet) cables.

Finally, the embodiments in the foregoing are not used for limiting the present disclosure, various modifications and variations may be made to the structure of the present disclosure are protected in the present disclosure by those skilled in this art without departing from the scope or spirit of the disclosure. Therefore, the scope of patent protection of the present disclosure is based on the scope of the attached patents.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A surveillance camera, comprising:
a connecting unit configured to communicate with other surveillance cameras via networks;
a camera lens having a first viewing zone;
a processing unit electrically connected to the camera lens and the connecting unit, configured to detect and determining whether anyone of the other surveillance cameras is disabled to communicate with the other surveillance cameras with the connecting unit; and
a viewing-zone changing element electrically connected to the processing unit, and configured to change the first viewing zone to overlap a second viewing zone of the disabled surveillance camera.

2. The surveillance camera of claim 1, wherein the viewing-zone changing element comprises:
a pan-tilt mechanism configured to change the first viewing zone to overlap the second viewing zone of the disabled surveillance camera by rotating the camera lens of the surveillance camera.

3. The surveillance camera of claim 2, further comprising:
a memory element electrically connected to the processing unit, and having at least one predetermined rotation angle stored therein,
wherein the pan-tilt mechanism rotates the camera lens to change the first viewing zone to overlap the second viewing zone of the disabled surveillance camera in accordance with the predetermined rotation angle.

4. The surveillance camera of claim 2, further comprising:
a positioning transceiver electrically connected to the processing unit, and configured to receive a location data from the disabled surveillance camera; and
a calculation element electrically connected to the processing unit, and configured to produce a suggested rotation angle by using the position data,
wherein the pan-tilt mechanism changes the first viewing zone to overlap the second viewing zone by rotating the camera lens in accordance with the suggested rotation angle.

5. The surveillance camera of claim 1, wherein the viewing-zone changing element comprises:
a zooming element configured to change the first viewing zone to overlap the second viewing zone of the disabled surveillance camera by zooming the first viewing zone.

6. The surveillance camera of claim 5, further comprising:
a memory element electrically connected to the processing unit, and having at least one predetermined zooming percentage stored therein,
wherein the zooming element zooms to change the first viewing zone to overlap the second viewing zone in accordance with the predetermined zooming percentage.

7. The surveillance camera of claim 1, wherein the processing unit is further configured to respectively request the other surveillance cameras to reply to the other surveillance cameras with the connecting unit via the networks.

8. The surveillance camera of claim 1, wherein the processing unit is further configured to respectively receive indication signals from the disabled surveillance camera with the connecting unit via the networks.

9. A surveillance system comprising:
at least one first surveillance camera having a first viewing zone; and
a second surveillance camera electrically connected to the first surveillance camera via networks, and having a second viewing zone being different from the first viewing zone,
wherein, when the first surveillance camera detects and determines that the second surveillance camera is disabled, the first surveillance camera actively changes the first viewing zone to overlap the second viewing zone of the second surveillance camera.

10. The surveillance system of claim 9, wherein the first surveillance camera comprises:
a camera lens covering the first viewing zone; and
a pan-tilt mechanism rotatably disposed on the camera lens, and configured to rotate the camera lens to change the first viewing zone to overlap the second viewing zone of the second surveillance camera in accordance with a predetermined rotation angle.

11. The surveillance system of claim 10, wherein the second surveillance camera further comprises a first positioning system transceiver for outputting a location data; and the first surveillance camera further comprises:
a second positioning transceiver for receiving a location data from the second surveillance camera via the networks; and
a calculation element electrically connected to the second positioning transceiver, and calculating out a suggested rotation angle in accordance with the location data received by the second positioning transceiver,
wherein the camera lens changes the first viewing zone to overlap the second viewing zone of the second surveillance camera by rotating the pan-tilt mechanism in accordance with the suggested rotation angle.

12. The surveillance system of claim 9, wherein the first surveillance camera comprises:
a zooming element disposed on the camera lens, and zooming to change the first viewing zone to overlap the second viewing zone of the second surveillance camera in accordance with a predetermined zooming percentage.

13. The surveillance system of claim 9, wherein the second surveillance camera comprises:
a vibration sensor configured to output an abnormal signal to the first surveillance camera via the networks when the vibration sensor detects that the second surveillance camera is moved.

14. The surveillance system of claim 9, wherein the second surveillance camera comprises:
a pixel variation sensor configured to output an abnormal signal to the first surveillance camera via the networks when the pixel variation sensor determines that two frames of the real-time videos of the second viewing zone are different.

15. The surveillance system of claim 9, wherein
the first surveillance camera comprises a first connecting unit; and
the second surveillance camera comprises a second connecting unit communicatively connected to the first connecting unit of the first surveillance camera via the networks,
when the first surveillance camera receives an abnormal signal from the second connecting unit of the second surveillance camera by the first connecting unit, the first surveillance camera determines that the second surveillance camera is disabled for outputting the real-time videos of the second viewing zone.

16. The surveillance system of claim 9, wherein the first surveillance camera comprises a first connecting unit; and
the second surveillance camera comprises a second connecting unit communicatively connected to the first connecting unit of the first surveillance camera via the networks,
wherein, when the second surveillance camera fails to reply a request sent from the first surveillance camera by the second connecting unit in a predetermined time, the first surveillance camera determines that the second surveillance camera is disabled as being failed to output the real-time videos of the second viewing zone.

17. The surveillance system of claim 9, wherein the first surveillance camera comprises:
an action table having at least one predetermined rotation angle, and the predetermined rotation angle corresponding to the second surveillance camera.

18. The surveillance system of claim 9, wherein the first surveillance camera comprises:
an action table having at least one zooming percentage, the predetermined zooming percentage corresponds to the second surveillance camera.

19. The surveillance system of claim 9, further comprising:
a control center electrically connected to the first surveillance camera and the second surveillance camera via the networks, and configured to receive real-time videos of at least one of the first viewing zone of the first surveillance camera and the second viewing zone of the second surveillance camera.

20. A method for security surveillance implemented on at least one of surveillance cameras covering a first viewing zone, and the method comprising:
communicatively connecting to the other surveillance cameras via networks;
communicating to the other surveillance cameras via the networks, and detecting and determining whether anyone of the other surveillance cameras is disabled as being failed to output real-time videos of a second viewing zone by; and
changing the first viewing zone thereof to overlap the second viewing zone of the disabled surveillance camera.

21. The method for security surveillance of claim 20, wherein the step of communicating to the other surveillance cameras via the networks, further comprises:
communicating to the other surveillance cameras via networks periodically.

22. The method for security surveillance of claim 20, wherein the step of detecting and determining whether anyone of the other surveillance cameras is disabled, further comprises:
detecting and determining whether any of the other surveillance cameras is functionally interrupted; and
when any of the other surveillance cameras is determined to be functionally interrupted, the one of the surveillance cameras is determined to be disabled.

23. The method for security surveillance of claim 22, wherein the step of detecting and determining whether anyone of the other surveillance cameras is functionally interrupted, further comprises:
detecting and determining whether an abnormal signal of any of the other surveillance cameras being vibrated is received from the one of the other surveillance cameras via the networks;
when the abnormal signal is received from the one of the other surveillance cameras via the networks, the one of the other surveillance cameras is determined to be functionally interrupted.

24. The method for security surveillance of claim 22, wherein the step of detecting and determining whether anyone of the other surveillance cameras is functionally interrupted, further comprises:
detecting and determining whether an abnormal signal is received from any of the other surveillance cameras via the networks, wherein the abnormal signal is outputted when two frames of the real-time videos of the second viewing zone is detected to be mainly different;
when the abnormal signal is received from any of the other surveillance cameras via the networks, the one of the other surveillance cameras is functionally interrupted.

25. The method for security surveillance of claim 20, wherein the step of detecting and determining whether anyone of the other surveillance cameras is disabled, further comprises:
requesting the other surveillance cameras to reply via the networks; and
determining whether anyone of the other surveillance cameras fails to reply in a predetermined period via the networks,
when anyone of the other surveillance cameras fails to reply in the predetermined period, the one of the other surveillance cameras is determined to be disabled.

26. The method for security surveillance of claim 20, wherein the step of changing the first viewing zone thereof for overlapping the second viewing zone of the disabled surveillance camera, further comprises:
changing the first viewing zone to overlap the second viewing zone of the disabled surveillance camera by rotating the surveillance camera.

27. The method for security surveillance of claim 20, wherein the step of changing the first viewing zone thereof to overlap the second viewing zone of the disabled surveillance camera, further comprises:
receiving a location data from the disabled surveillance camera;
producing a suggested rotation angle by using the location data; and
changing the first viewing zone to overlap the second viewing zone of the disabled surveillance camera by rotating the surveillance camera in accordance with the suggested rotation angle.

28. The method for security surveillance of claim 20, wherein the step of changing the first viewing zone thereof to overlap the second viewing zone of the disabled surveillance camera, further comprises:
zooming to change the first viewing zone to overlap the second viewing zone of the disabled surveillance camera.
